(19) United States
(12) Patent Application Publication
(10) Pub. No.: US 2011/0005362 A1
(43) Pub. Date: Jan. 13, 2011

(54) Hole punch

(76) Inventor: Shun-Yu Wang, Taipei (TW)

Correspondence Address: Muncy, Geissler, Olds & Lowe, PLLC, 4000 Legato Road, Suite 310, FAIRFAX, VA, 22033, US

(21) Appl. No.: 11/976,594

(22) Filed: Oct. 25, 2007

(51) Int. Cl. B26D 7/01; B26D 5/10

(52) U.S. Cl. 83/468.8; 83/613

(57) ABSTRACT

An improved hole punch, wherein a gap is formed between a base plate located at a lower portion and a main body, which is provided with a pivot shaft pivotal configured with a pressure plate. A through hole is defined in the main body beneath the pressure plate, and a press key is located above the through hole. A punching pin mounted with a spring is disposed beneath the press key. An adjusting plate is symmetrically pivoted on two sides of the gap, and an adjusting bar penetrates the rear end of the main body. Accordingly, rotatably adjusting the two adjusting plates to the corner angle of paper enables perforating the paper corner placed within the gap, moreover, the front end position of the adjusting bar can be adjusted to enable the paper edge to be retained thereat and enable punching holes at a consistent distance from the paper edge.

### BACKGROUND OF THE INVENTION

(a) Field of the Invention

The present invention relates to an improved hole punch, and more particularly to a hole punch that can be adjusted to a configuration capable of punching the corners of paper, and which enables adjusting distance from the paper edge where holes are punched.

(b) Description of the Prior Art

Referring to FIGS. 1 and 2, which show a hole punch of prior art, comprising a main body 10, a lower portion of which is configured with a L-shaped base plate 11. A perpendicular connecting portion 111 at a rear end of the base plate 11 is connected to a rear end of the main body 10, thereby causing a gap 12 to be formed between the main body 10 and the base plate 11 for placing sheets of paper 2 therein ready for punching holes. A through hole is defined in a front end of the main body 10, and a press key 13, an upper end of which protrudes out from the through hole, is located at an upper portion of the through hole. A punching pin 14 is disposed within the through hole beneath the press key 13, and a bottom end of the punching pin 14 is fitted with knife edges 141. A spring 15 is mounted on the punching pin 14, and the upper end of the spring 15 abuts against the upper end of the punching pin 14, while the lower end abuts against the inner bottom surface of the main body 10, thereby enabling the press key 13 and the punching pin 14 to use the restoring elasticity of the spring 15 to return to their original positions after being pressed down. Accordingly, the paper 2 requiring punched holes can be placed in the gap 12, and the fingers are used to press down on the press key 13 to cause the knife edges 141 of the punching pin 14 to punch holes in the paper 2.

However, great effort is expended in operating such a hole punch of prior art, and is only able to punch holes in the margin of the paper 2. Moreover, Indent distance for hole punching (that is, distance from the edge of the paper 2 to the hole punching position) must be adjusted manually, resulting in the inability to punch holes in the corners of the paper 2, as well as punching holes at an inconsistent distance from the paper edge. Hence, the prior art is extremely inconvenient.

### SUMMARY OF THE INVENTION

Hence, in light of the shortcomings of the aforementioned hole punch of the prior art, the inventor of the present invention, having accumulated knowhow and manufacturing experience of diverse hole punch products, attentively researched various methods to resolve such drawbacks, which, following continuous research and improvements, culminated in the design of a completely new and improved hole punch of the present invention.

An objective of the present invention is to provide an improved hole punch that can be adjusted to a configuration capable of punching the corners of paper, and which enables adjusting distance from the paper edge where holes are punched.

According to the aforementioned objective, the hole punch of the present invention comprises a main body, a lower portion of which is configured with a L-shaped base plate, thereby forming a gap between the main body and the base plate for placing sheets of paper therein ready for punching holes. The main body is configured with a pivot shaft, and a pressure plate is pivotal configured on the pivot shaft. A through hole is defined in the main body beneath the pressure plate, and a press key, an upper end of which protrudes out from the through hole, is located at an upper portion of the through hole. A punching pin is disposed within the through hole beneath the press key, and a spring is mounted on the punching pin, thereby enabling the press key and the punching pin to use the restoring elasticity of the spring to return to their original positions after being pressed down. An adjusting plate is symmetrically pivotal configured on two sides at an inner end of the gap. An adjusting bar penetrates the rear end of the main body, which enables forward and backward movement of the front end of the adjusting bar in the gap. Accordingly, when in use, rotatably adjusting the two adjusting plates to the angle (90 degrees) of the corner of paper enables the corner of the paper to be placed into the gap ready for punching holes, moreover, position of the front end of the adjusting bar can be adjusted to enable the edge of the paper to be retained at the position of the front end of the adjusting bar and enable punching holes at a consistent distance from the paper edge.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view depicting an external appearance of a prior art hole punch.

FIG. 2 shows a schematic cross-sectional view of the prior art hole punch.

FIG. 3 shows an elevational view depicting an external appearance of a hole punch according to the present invention.

FIGS. 4a, 4b show schematic cross-sectional views of the hole punch according to the present invention.

FIG. 5 shows a partial enlarged schematic view of the hole punch according to the present invention.

FIGS. 6a, 6b show schematic views depicting operation of the hole punch according to the present invention.

FIGS. 7a, 7b show schematic views depicting other movements of the hole punch according to the present invention.

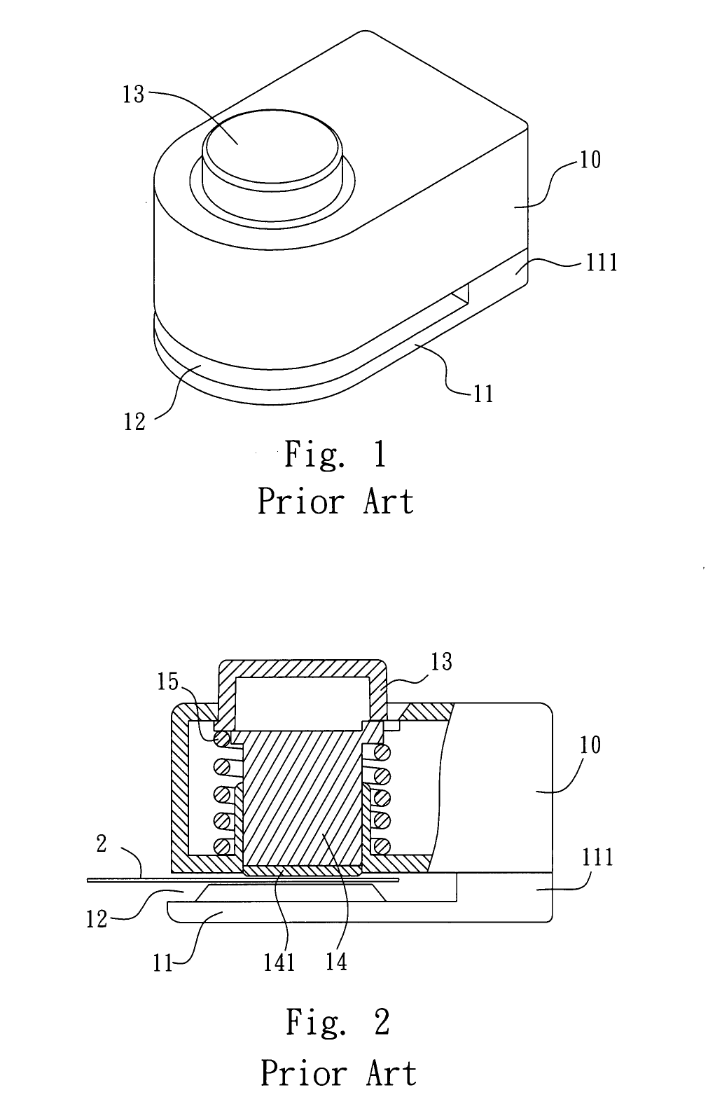

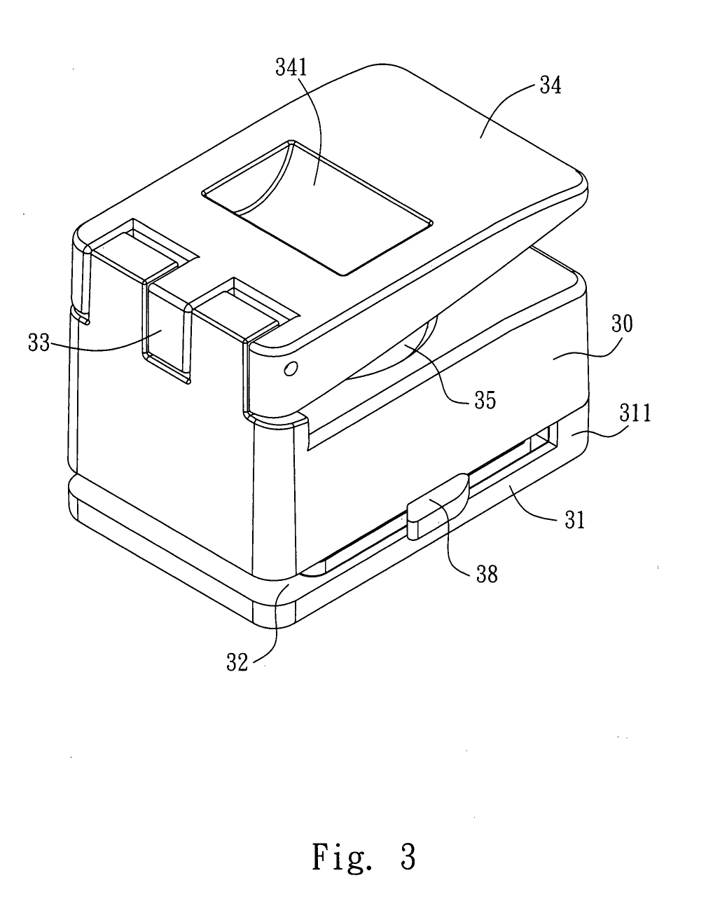

### DETAILED DESCRIPTION OF THE PREFERRED EMBODIMENTS

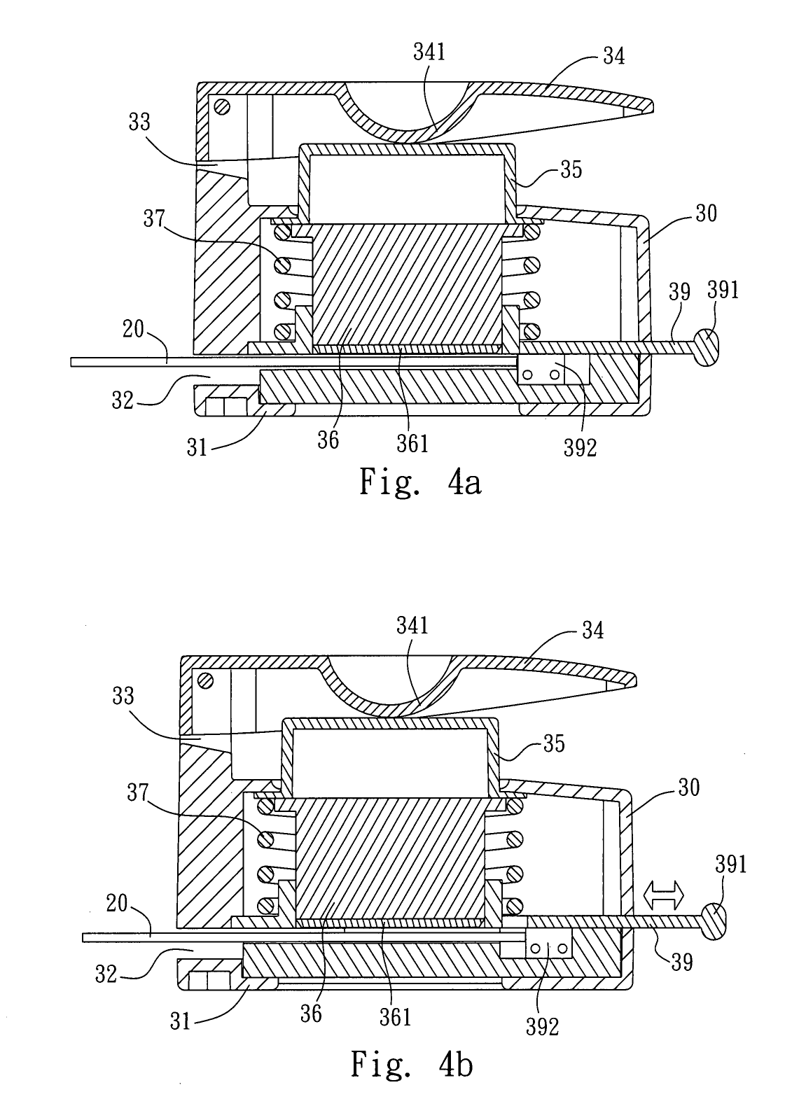

The present invention relates to an improved hole punch, as depicted in FIGS. 3, 4a, 4b, 5, 6a and 6b, wherein a hole punch of the present invention comprises a main body 30, a lower portion of which is configured with a L-shaped base plate 31. A perpendicular connecting portion 311 at a rear end of the base plate 31 is connected to a rear end of the main body 30, thereby causing a gap 32 to be formed between the main body 30 and the base plate 31 for placing sheets of paper 20 therein ready for punching holes.

The main body 30 is configured with a pivot shaft 33, and a pressure plate 34 is pivot configured to the pivot shaft 33. A through hole is defined in the main body 30 beneath the pressure plate 34, and a press key 35, an upper end of which protrudes out from the through hole, is located at an upper portion of the through hole. A punching pin 36 is disposed within the through hole beneath the press key 35, and a bottom end of the punching pin 36 is fitted with knife edges 361. A spring 37 is mounted on the punching pin 36, and the upper end of the spring 37 abuts against the upper end of the punching pin 36, while the bottom end abuts against the inner bottom surface of the main body 30, thereby enabling the press key 35 and the punching pin 36 to use the restoring elasticity of the spring 37 to return to their original positions after being pressed down. An adjusting plate 38 is symmetrically pivotal configured on two sides at an inner end of the gap 32, thereby enabling the two adjusting plates 38 to be rotated within the gap 32.

According to the assembly of the aforementioned components, when punching holes, the paper 20 is placed into the gap 32, and pressing of the pressure plate 34 is used to cause the bottom surface of the pressure plate 34 to press against the press key 35 and the punching pin 36, thereby causing the knife edges 361 of the punching pin 36 to punch holes in the paper 20. Furthermore, prior to punching holes, the two adjusting plates 38 can be rotated to the angle (90 degrees) of the corner of the paper 20, thereby enabling the corners of the paper 20 to be placed into the gap 32 for punching holes therein.

Because the pressure plate 34 is used to press against the press key 35 and the punching pin 36, and because the front end of the pressure plate 34 is pivotal configured on the pivot shaft 33, thus, compared to hole punches of prior art, less effort is expended in the direct use of the fingers to press the press key 35.

Referring again to FIGS. 3, 4a, 4b, and 5, the bottom surface of the pressure plate 34 is configured with an arc-shaped pressing portion 341 of firm material so as to be correspondingly positioned on the press key 35, thereby increasing strength and pressing efficiency of the pressure plate 34.

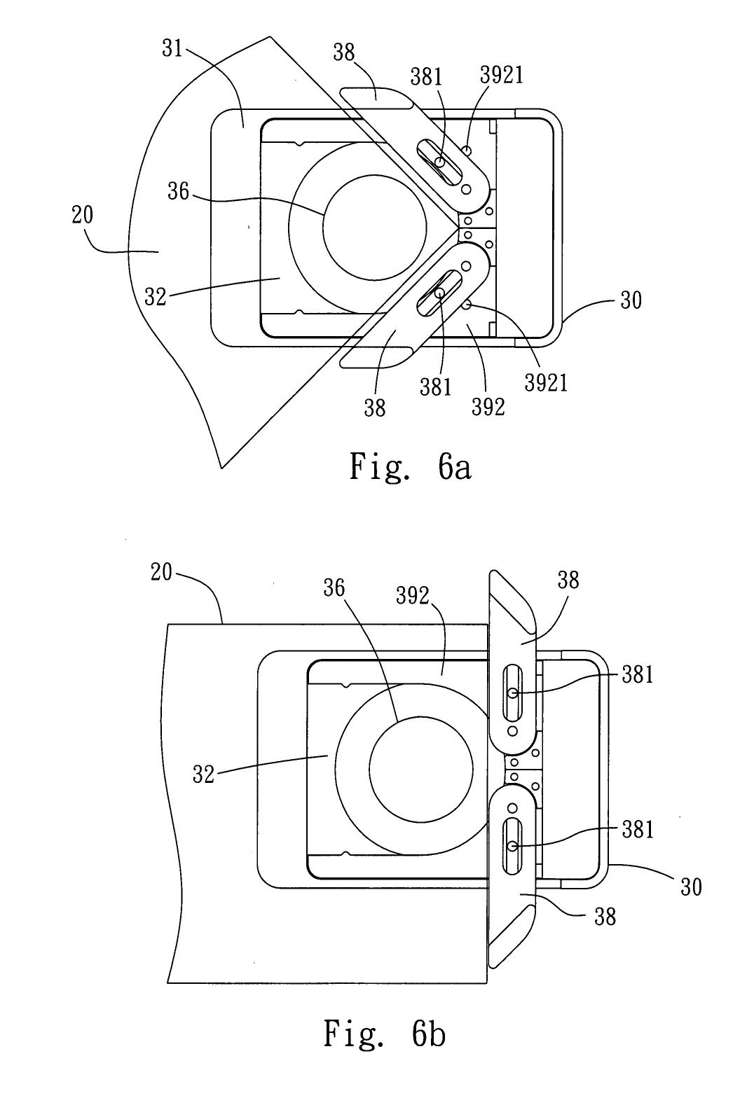

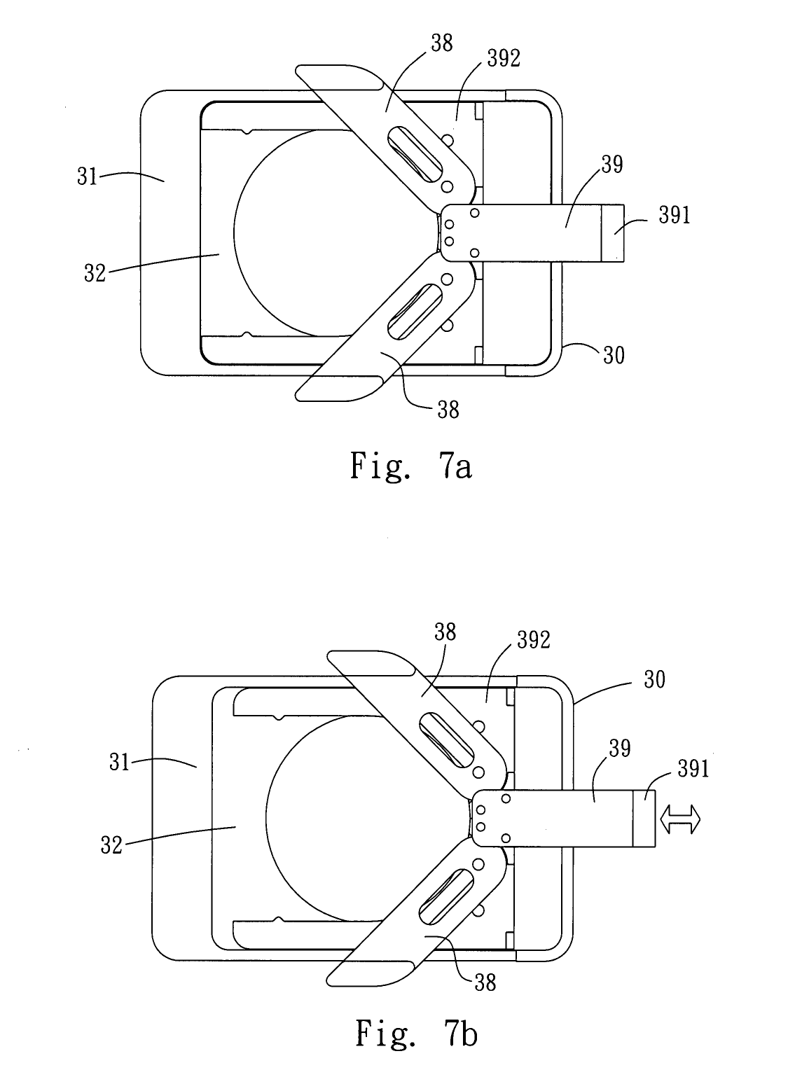

Referring to FIGS. 6a, 6b, 7a, and 7b, an adjusting bar 39 penetrates the rear end of the main body 30, and the front end of the adjusting bar 39 is positioned within the gap 32 and connected to sliding pieces 392 located within the gap 32, moreover, inner ends of the two adjusting plates 38 are pin connected to the sliding pieces 392. The rear end of the adjusting bar 39 is positioned outside the main body 30, and a holding portion 391 is located at the rear end of the adjusting bar 39. Accordingly, holding the holding portion 391 enables forward and backward adjustment of the position of the front end of the adjusting bar 39. When in use, the position of the front end of the adjusting bar 39 can be adjusted to enable the edge of the paper 20 to be retained by the two adjusting plates 38 at the position of the front end of the adjusting bar 39 and enable punching holes at a consistent distance from the edge of the paper 20; or the position of the front end of the adjusting bar 39 can be adjusted to enable punching holes at different distances from the edge of the paper 20 according to needs.

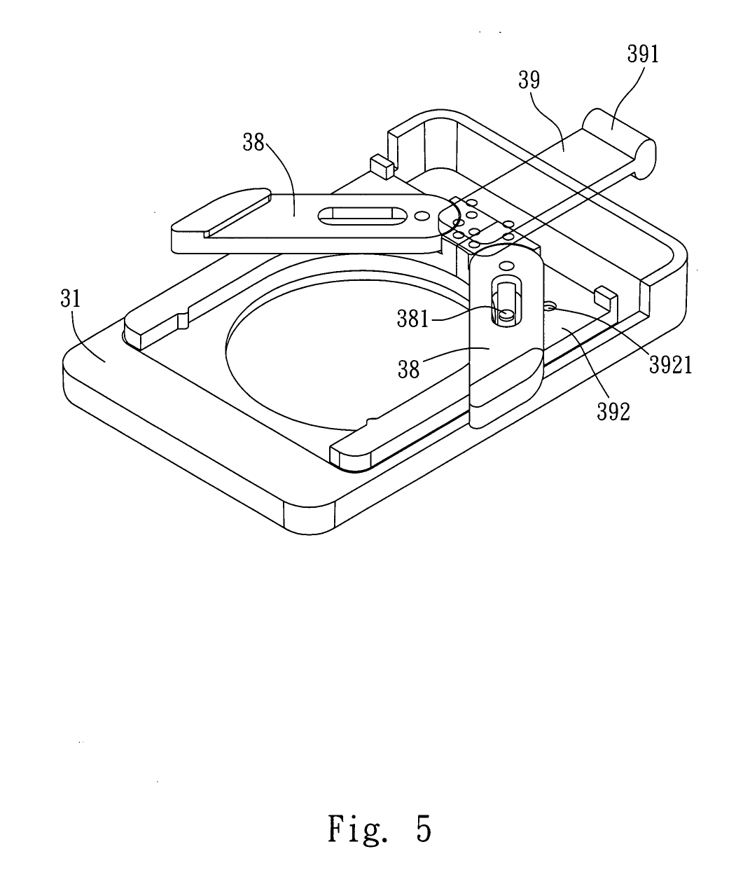

Referring again to FIGS. 5, 6a, 6b, 7a and 7b, concave clasp points 3921 are defined at positions on the sliding pieces 392 when the two adjusting plates 38 have been completely opened or rotatably opened to a 90 degree angle, and protruding points 381 protrude from the two adjusting plates 38 corresponding to positions of concave clasp points 3921; accordingly, when the two adjusting plates 38 have been completely opened or rotatably opened to a 90 degree angle position, then the protruding points 381 clasp into the concave clasp points 3921 and fix the two adjusting plates 38 at those positions.

In conclusion, the improved hole punch of the present invention is assuredly provided with an Innovative structure not found in prior art. Moreover, no similar products have been seen in any publication or in the market, the present invention is thus provided with undoubted originality. In addition, the present invention is provided with unique characteristics and functionality that are without comparison in prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A hole punch, comprising:
a main body, a lower portion of the main body is configured with a L-shaped base plate, a perpendicular connecting portion at a rear end of the base plate is connected to a rear end of the main body, thereby forming a gap between the main body and the base plate for placing sheets of paper therein ready for punching holes;
a pivot shaft fitted to the main body, and a pressure plate is pivotal configured on the pivot shaft, a through hole is defined in the main body beneath the pressure plate;
a press key located at an upper portion of the through hole, an upper end of the press key protrudes out from the through hole, a punching pin is disposed within the through hole beneath the press key, and a bottom end of the punching pin is fitted with knife edges, a spring is mounted on the punching pin, and the upper end of the spring abuts against the upper end of the punching pin, while the bottom end abuts against the inner bottom surface of the main body, thereby enabling the press key and the punching pin to use the restoring elasticity of the spring to return to their original positions after being pressed down;
two adjusting plates symmetrically pivotal configured on two sides at an inner end of the gap, thereby enabling the two adjusting plates to be rotated within the gap; whereby prior to punching holes, the two adjusting plates can be rotated to the angle of the corner of paper, thereby enabling the corners of the paper to be placed into the gap for punching holes therein.

2. The hole punch according to claim 1, wherein the bottom surface of the pressure plate is configured with an arc-shaped pressing portion of firm material so as to be correspondingly positioned on the press key.

3. The hole punch according to claim 1, wherein an adjusting bar penetrates the rear end of the main body, and the front end of the adjusting bar is positioned within the gap and connected to sliding pieces located within the gap, moreover, inner ends of the two adjusting plates are pin connected to the sliding pieces, the rear end of the adjusting bar is positioned outside the main body, and a holding portion is located at the rear end of the adjusting bar, whereby holding the holding portion enables forward and backward adjustment of the position of the front end of the adjusting bar to enable the edge of paper to be retained by the two adjusting plates at the position of the front end of the adjusting bar and to enable punching holes at a consistent distance from the paper edge.
